(19) United States
(12) Patent Application Publication
(10) Pub. No.: US 2026/0105875 A1
(43) Pub. Date: Apr. 16, 2026

(54) DISPLAY DRIVE DEVICE AND DISPLAY DEVICE COMPRISING SAME

(71) Applicant: LX SEMICON CO., LTD., Daejeon (KR)

(72) Inventors: Da Sol WON, Daejeon (KR); Ju Ho LEE, Daejeon (KR); Jung Min CHOI, Daejeon (KR)

(73) Assignee: LX SEMICON CO., LTD., Daejeon (KR)

(21) Appl. No.: 19/115,314

(22) PCT Filed: Sep. 25, 2023
(86) PCT No.: PCT/KR2023/014628

§ 371 Date: Mar. 26, 2025

(30) Foreign Application Priority Data
Sep. 29, 2022 (KR) 10-2022-0123893

(51) Int. Cl. G09G 3/20

(52) U.S. Cl. CPC G09G 3/2007; G09G 2310/027; G09G 2310/0289; G09G 2310/08; G09G 2330/021

(57) ABSTRACT

A display drive device according to one aspect of the present invention, that can effectively reduce current consumption by reducing the level of a high-potential operation voltage supplied to a level shifter, comprises: a gray-scale voltage generation circuit which generates a plurality of gray-scale voltages using a first operation voltage and a ground voltage; the level shifter which uses a target gray-scale voltage lower than the first operation voltage from among the plurality of gray-scale voltages so as to level shift the voltage of input data to the target gray-scale voltage; and a gray-scale voltage transmission line which transmits the target gray-scale voltage from the gray-scale voltage generation circuit to the level shifter.

### TECHNICAL FIELD

The present invention relates to a semiconductor integrated circuit, and more particularly, to a display driving device of a display device.

However, for simplicity of description, a source driver integrated circuit (IC), which is an example of the display driving device, will be described in the present specification, but the present invention is applicable to any type of display driving devices.

### BACKGROUND ART

A source drive integrated circuit (IC) that drives data lines included in a display device includes a digital-to-analog converter (DAC, hereinafter referred to as “DAC”) and level shifters.

Each of the level shifters shifts the voltage level of each of the input digital video signals to generate an output digital video signal with a shifted voltage level, in order to control the on or off state of each switch that is included in the DAC and consumes dynamic current.

In response to the output digital video signals whose voltage levels are shifted by the level shifters, the switches included in the DAC output any one of the grayscale voltages generated by a grayscale voltage generator to any one of the data lines.

However, as the resolution of the display device increases, the number of source driver ICs also increases in proportion to the resolution, and as the number of source driver ICs increases, the number of level shifters also increases. This results in a problem of increased current consumption caused by the level shifters.

### DISCLOSURE

### Technical Problem

To solve the above-mentioned problems, the present invention aims to provide a source driver IC capable of effectively reducing current consumption by decreasing the level of a high-potential operating voltage supplied to a level shifter, and a display device including the same.

In addition, the present invention aims to provide a source driver IC in which a plurality of level shifters may share current, and a display device including the same.

### Technical Solution

A display driving device according to one aspect of the present invention for achieving the aforementioned technical objectives includes: a grayscale voltage generation circuit configured to generate a plurality of grayscale voltages using a first operating voltage and a ground voltage; a level shifter configured to level-shift a voltage of input data to a target grayscale voltage, which is lower than the first operating voltage among the plurality of grayscale voltages, using the target grayscale voltage; and a grayscale voltage transmission line configured to transmit the target grayscale voltage from the grayscale voltage generation circuit to the level shifter.

A display device according to another aspect of the present invention for achieving the aforementioned technical objectives includes: a source driver IC configured to drive data lines included in a display panel; and a timing controller configured to transmit input data to be displayed through the display panel to the source driver IC and control an operation of the source driver IC, wherein the source driver IC includes: a grayscale voltage generation circuit configured to generate a first group of grayscale voltages using a first operating voltage and a second operating voltage, and generate a second group of grayscale voltages using the second operating voltage and a ground voltage; a first grayscale voltage transmission line configured to transmit a first grayscale voltage among the first group of grayscale voltages; a second grayscale voltage transmission line configured to transmit a second grayscale voltage among the second group of grayscale voltages; first level shifters, each connected between the first grayscale voltage transmission line and a ground that supplies the ground voltage, and configured to level-shift a voltage of each bit included in first parallel data among the input data to the first grayscale voltage; and second level shifters, each connected between the second grayscale voltage transmission line and the ground, and configured to level-shift a voltage of each bit included in second parallel data among the input data to the second grayscale voltage.

### Effect of the Disclosure

According to the present invention, the current consumption of the level shifters in the source driver IC may be reduced by decreasing the level of a high-potential operating voltage supplied to the level shifters, thereby effectively reducing the current consumption of the source driver IC.

Furthermore, according to the present invention, the second level shifter may share a current with the first level shifter, thereby maximizing the reduction in current consumption of the level shifters.

### BRIEF DESCRIPTION OF THE DRAWINGS

FIG. 1 is a block diagram of a display device including a source driver IC according to one embodiment of the present invention.

FIG. 2 is a block diagram of a source driver IC included in the display device of FIG. 1.

FIG. 3 is a timing diagram illustrating the operation of latch circuits that latch odd-numbered data and even-numbered data supplied to the source driver IC of FIG. 2.

FIG. 4 is a conceptual diagram of a grayscale voltage generation circuit included in the source driver IC of FIG. 2.

FIG. 5 illustrates a range of voltage levels used in the source driver IC of FIG. 2.

FIG. 6 is a circuit diagram of a first level shifter included in the source driver IC of FIG. 2.

FIG. 7 is a circuit diagram of a second level shifter included in the source driver IC of FIG. 2.

FIG. 8 is a circuit diagram of a first digital-to-analog converter included in the source driver IC of FIG. 2.

FIG. 9 is a circuit diagram of a second digital-to-analog converter included in the source driver IC of FIG. 2.

FIG. 10 is a graph illustrating a comparison between power consumption of a source driver IC according to the present invention and power consumption of a source driver IC according to the prior art.

### BEST MODE

Throughout the specification, the same reference numerals refer to substantially the same components. In the following description, detailed descriptions of configurations and features known in the art may be omitted if they are not relevant to the core configuration of the present invention. Terms used in this specification should be understood as follows.

The advantages and features of the present invention, and methods of achieving them will be apparent from the embodiments described in detail below in conjunction with the accompanying drawings. However, the present invention is not limited to the following embodiments, but may be implemented in various different forms; rather, the present embodiments are provided to make the description of the present invention complete and to allow those skilled in the art to fully understand the scope of the present invention, and the present invention is defined only within the scope of the appended claims.

The shapes, sizes, proportions, angles, numbers and the like shown in the accompanying drawings for the purpose of illustrating the embodiments of the present invention are merely examples, and the present invention is not limited thereto. Identical reference numerals may designate identical components throughout the description. Further, in describing the present invention, detailed descriptions of known related technologies may be omitted if it is considered to unnecessarily obscure the gist of the present invention.

The terms such as “comprising,” “including,” “having,” and “consisting of” used herein are generally intended to allow other components to be added unless the terms are used with the term “only.” References to components of a singular noun include the plural of that noun, unless specifically stated otherwise.

In interpreting components, they are construed to include a margin of error, even if it is not explicitly stated.

When describing a positional relationship, for example, “on,” “above,” “below,” or “next to” describes the positional relationship of two parts, one or more other parts may be located between the two parts, unless “immediately” or “directly” is used.

When describing a temporal contextual relationship is described, for example, such as “after,” “following,” “next to,” or “before,” it may also include non-contiguous cases unless “immediately” or “directly” is used.

The first, the second, and so on are used to describe various components, but these components are not limited by these terms. These terms are used only to distinguish one component from another. Therefore, the first component referred to herein may also be a second component within the technical idea of the present invention.

It should be understood that the term “at least one” includes any combination that can be presented from one or more relevant items. For example, the phrase of “at least one of the first, second, and third items” may mean each of the first, second, or third items, as well as any combination of items that may be presented from two or more of the first, second, and third items.

Each of the features of various embodiments of the present invention may be coupled or combined with one another in whole or in part, and may be technologically interlocked and operated in various ways, and each of the embodiments may be carried out independently or in conjunction with one another.

Hereinafter, embodiments of the present specification will be described in detail with reference to the accompanying drawings.

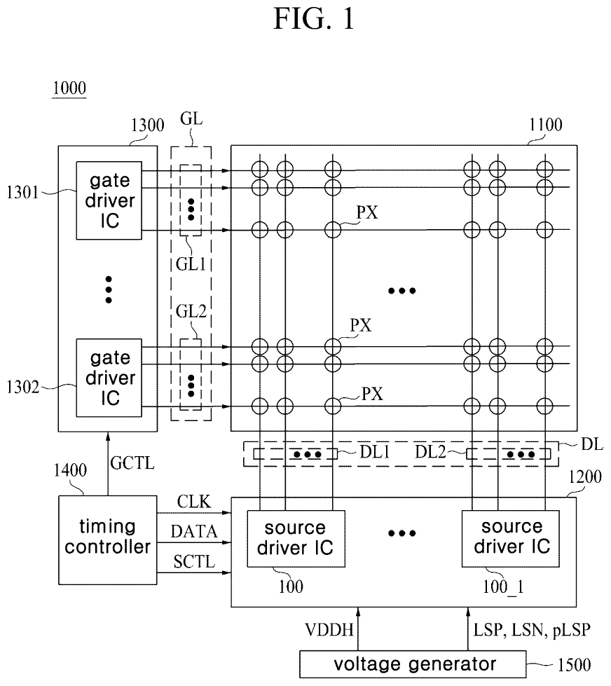

FIG. 1 is a block diagram of a display device including a source driver IC according to one embodiment of the present invention.

As shown in FIG. 1, a display device 1000 according to the present invention includes a display panel 1100, a source driver IC block 1200, a gate driver IC block 1300, a timing controller 1400, and a voltage generator 1500. Although the voltage generator 1500 is exemplarily illustrated outside the source driver IC block 1200 in FIG. 1, the voltage generator 1500 may be implemented within the source driver IC block 1200 or within each of source driver ICs 100 and/or 100_1, depending on embodiments.

The display device 1000 may be a liquid crystal display (LCD) device, a light-emitting diode (LED) display device, an organic LED (OLED) display device, or an active-matrix organic light-emitting diode (AMOLED) display device. For example, the display device 1000 may be a laptop computer.

The display panel 1100 includes a plurality of gate lines GL, a plurality of data lines DL, and a plurality of pixels PX. The plurality of pixels PX are connected to each of the gate lines GL and each of the data lines DL and arranged in a matrix form.

The source driver IC block 1200 includes the plurality of source driver ICs 100 and 100_1 that drive the data lines DL. In one embodiment, the data lines DL may be referred to as channels, and the source driver ICs 100 and 100_1 may be referred to as data driver ICs.

For example, a first source driver IC 100 drives a first group of data lines DL1 among the data lines DL, and a second source driver IC 100_1 drives a second group of data lines DL2 among the data lines DL. It is assumed that the structures of the source driver ICs 100 and 100_1 are identical.

The gate driver IC block 1300 includes a plurality of gate driver ICs 1301 and 1302 that generate gate driving signals to drive the gate lines GL.

For example, a first gate driver IC 1301 generates first gate driving signals for driving a first group of gate lines GL1 among the gate lines GL, and a second gate driver IC 1302 generates second gate driving signals for driving a second group of gate lines GL2 among the gate lines GL. It is assumed that the structures of the gate driver ICs 1301 and 1302 are identical.

The timing controller 1400 generates gate driver control signals GCTL for controlling the operation of each of the plurality of gate driver ICs 1301 and 1302, and outputs them to the plurality of gate driver ICs 1301 and 1302.

Additionally, the timing controller 1400 generates a clock signal CLK, input data DATA, and source driving control signals SCTL and outputs them to the plurality of source driver ICs 100 and 100_1.

The voltage generator 1500 generates a first operating voltage VDDH and a second operating voltage HVDD and outputs them to the plurality of source driver ICs 100 and 100_1. In one embodiment, the second operating voltage HVDD may be a voltage corresponding to half of the first operating voltage VDDH, that is, 0.5VDDH.

In one embodiment, the voltage generator 1500 may additionally generate a bias voltage LSP to be supplied to the source driver ICs 100 and 100_1.

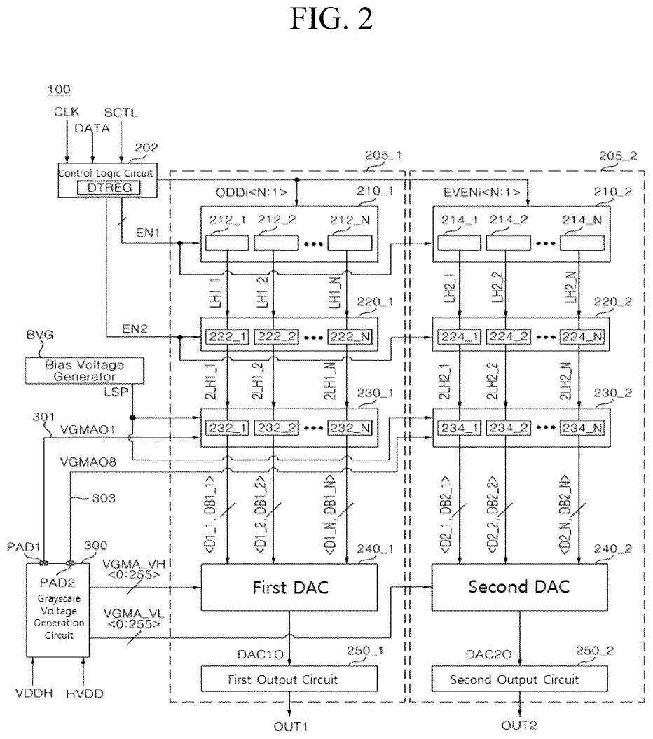

FIG. 2 is a block diagram of a source driver IC included in the display device of FIG. 1.

Referring to FIGS. 1 and 2, since the structures of the source driver ICs 100 and 100_1 are identical, the structure and operation of the first source driver IC 100 will be described in detail (or representatively) with reference to FIGS. 1 to 9.

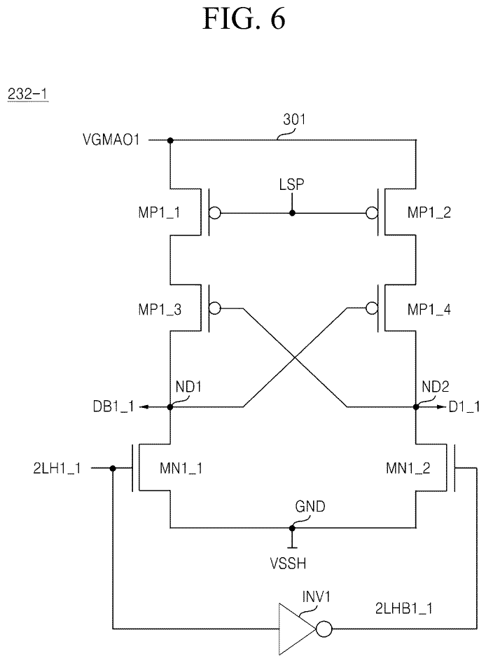

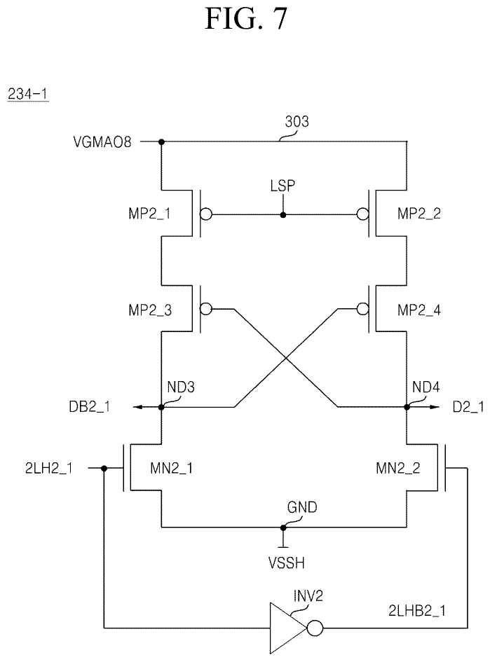

The first source driver IC 100 includes a control logic circuit 202, a first data processing circuit (or odd-numbered data processing circuit) 205_1, a second data processing circuit (or even-numbered data processing circuit) 205_2, a grayscale voltage generation circuit 300, and a bias voltage generator BVG. The bias voltage generator BVG generates the bias voltage LSP to be supplied to each of level shifters 232_1 to 232_N and 234_1 to 234_N. Referring to FIGS. 6 and 7, the bias voltage generator BVG generates the bias voltage LSP having a low level.

The control logic circuit 202 stores the input data (e.g., RGB data) DATA in a data register DTREG using the clock signal CLK, and generates first latch enable signals EN1 and a second latch enable signal EN2 using the source driving control signals SCTL.

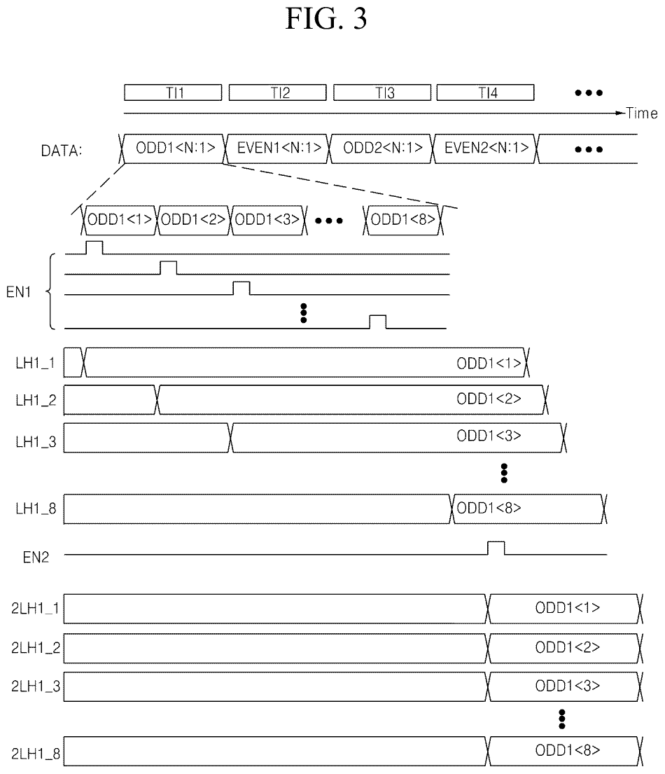

FIG. 3 is a timing diagram illustrating the operation of latch circuits that latch odd-numbered data and even-numbered data supplied to the source driver IC of FIG. 2.

From the perspective of input (or processing) time, data ODD1<N:1>, EVEN1<N:1>, ODD2<N:1>, EVEN2<N:1>, . . . shown in FIG. 3 are continuous (or serial) data.

For example, each data ODD1<N:1>, EVEN1<N:1>, ODD2<N:1>, EVEN2<N:1>, . . . may be N-bit serial data, and each of the N bits may be data 1 (or logic 1) or data 0 (or logic 0). The voltage of data 1 (or logic 1) may be smaller than the first operating voltage VDDH or the second operating voltage VDDH.

Referring to FIGS. 2 and 3, the control logic circuit 202 extracts (or separates) odd-numbered data ODDi<N:0> and even-numbered data EVENi<N:0> from the serial input data DATA using the clock signal CLK, and outputs the extracted data ODDi<N:0> or EVENi<N:0> to the first data processing circuit 205_1 and the second data processing circuit 205_2 in a time-division manner.

The first data processing circuit 205_1 receives the odd-numbered data ODDi<N:0> outputted from the control logic circuit 202, processes it (e.g., performs voltage level shifting and digital-to-analog conversion), and outputs a processing result OUT1 to any one of the first data lines DL1. Here, N and i are natural numbers, and for simplicity of description, N is assumed to be 8 in this specification.

The second data processing circuit 205_2 receives the even-numbered data EVENi<N:0> outputted from the control logic circuit 202, processes it (e.g., performs voltage level shifting and digital-to-analog conversion), and outputs a processing result OUT2 to another one of the first data lines DL1.

The first data processing circuit 205_1 includes a first latch circuit 210_1, a second latch circuit 220_1, a first level shifter circuit 230_1, a first DAC 240_1, and a first output circuit 250_1.

The first latch circuit 210_1 includes first latches 212_1 to 212_8, and latches (or converts) 8-bit serial odd-numbered data ODDi<8:1> into 8-bit parallel odd-numbered data LH1_1 to LH1_8 in response to the first latch enable signals EN1.

In one embodiment, each of the first latches 212_1 to 212_8 may be a D-flip-flop capable of latching 1-bit data, and the first latch enable signals EN1 may be parallel signals activated at different timings, as shown in FIG. 3.

During a first operation time TI1, when 8-bit first odd-numbered serial data ODD1<8:1> is sequentially inputted to the first latch circuit 210_1, the first latches 212_1 to 212_8 latch the respective data ODD1<1> to ODD1<8> in response to the respective first latch enable signals EN1, and output the latched data LH1_1 to LH1_8 to the second latch circuit 220_1.

The second latch circuit 220_1 includes second latches 222_1 to 222_8, and the second latches 221_1 to 222_8 latch the respective data LH1_1 to LH1_8 in response to the second latch enable signal EN2, and output latched data 2LH1_1 to 2LH1_8 to the first level shifter circuit 230_1.

The second data processing circuit 205_2 includes a third latch circuit 210_2, a fourth latch circuit 220_2, a second level shifter circuit 230_2, a second DAC 240_2, and a second output circuit 250_2.

The third latch circuit 210_2 includes third latches 214_1 to 214_8, and latches (or converts) 8-bit serial even-numbered data EVENi<8:1> into 8-bit parallel even-numbered data LH2_1 to LH2_8 in response to the first latch enable signals EN1.

For example, each of the third latches 214_1 to 214_8 may be a D-flip-flop capable of latching 1-bit data, and the first latch enable signals EN1 may be parallel signals activated at different timings, as shown in FIG. 3.

The activation timing of each of the first latch enable signals EN1 supplied to the first latch circuit 210_1 is different from the activation timing of each of the first latch enable signals EN1 supplied to the third latch circuit 210_3.

During a second operation time TI2, when 8-bit first even-numbered serial data EVEN1<8:1> is sequentially inputted to the third latch circuit 210_2, the third latches 214_1 to 214_8 latch the respective data EVEN1<1> to EVEN1<8> in response to the respective first latch enable signals EN1, and output the latched data LH2_1 to LH2_8 to the fourth latch circuit 220_2.

The fourth latch circuit 220_2 includes fourth latches 224_1 to 224_8, and the fourth latches 224_1 to 224_8 latch the respective data LH2_1 to LH2_8 in response to the second latch enable signal EN2, and output latched data 2LH2_1 to 2LH2_8 to the second level shifter circuit 230_2.

The process of handling 8-bit second odd-numbered serial data ODD2<8:1> during a third operation time TI3 is the same as or similar to the process of handling the 8-bit first odd-numbered serial data ODD1<8:1> during the first operation time TI1 described with reference to FIG. 3. Therefore, a description of the process of handling the 8-bit second odd-numbered serial data ODD2<8:1> is omitted.

In Addition, the process of handling 8-bit second even-numbered serial data EVEN2<8:1> during a fourth operation time TI4 is the same as or similar to the process of handling the 8-bit first even-numbered serial data EVEN1<8:1> during the second operation time TI2. Therefore, a description of the process of handling the 8-bit second even-numbered serial data EVEN2<8:1> is omitted.

The process of handling each data EVEN1<8:1>, ODD2<8:1>, EVEN2<8:1>, or the like is the same as or similar to the process of handling the data ODD1<8:1> described with reference to FIG. 3, and thus a description thereof is omitted.

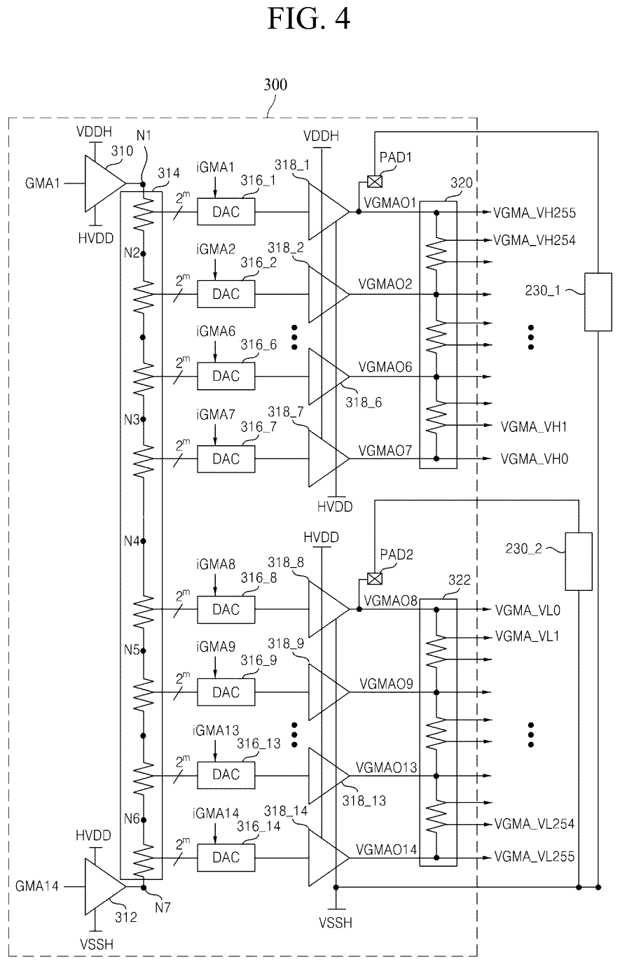

FIG. 4 is a conceptual diagram of a grayscale voltage generation circuit included in the source driver IC of FIG. 2.

Referring to FIG. 4, the grayscale voltage generation circuit 300 includes a first main voltage buffer 310, a second main voltage buffer 312, a first resistor string 314, a plurality of selection circuits 316_1 to 316_14, a plurality of buffers 318_1 to 318_14, a second resistor string 320, and a third resistor string 322. The plurality of selection circuits 316_1 to 316_14 may be referred to as decoders.

In one embodiment, each of the buffers 310, 312, and 318_1 to 318_14 may be a unit gain buffer or a unit-gain amplifier.

The first main voltage buffer 310 receives a first voltage signal GMA1 and outputs a voltage that swings between the first operating voltage VDDH and the second operating voltage HVDD. As described above, the second operating voltage HVDD may be half of the first operating voltage VDDH, that is, HVDD=0.5VDDH.

The second main voltage buffer 312 receives a second voltage signal GMA14 and outputs a voltage that swings between the second operating voltage HVDD and ground voltage VSSH.

The first resistor string 314 includes a first group of resistors connected in series between the output terminal of the first main voltage buffer 310 and the output terminal of the second main voltage buffer 312.

Each of the plurality of selection circuits 316_1 to 316_14 outputs a gamma reference voltage selected from 256 voltages generated by distributing a voltage difference between two corresponding nodes among a plurality of nodes N1 to N7 included in the first resistor string 314.

Each of the selection circuits 316_1 to 316_14 may be a 2^{m}-to-1 selector. For example, when m is 8, each of the selection circuits 316_1 to 316_14 may be an 8-bit digital-to-analog converter. Although FIG. 4 illustrates that 256 voltages are inputted to each of the plurality of selection circuits 316_1 to 316_14, this is merely an example. For example, each of selection signals iGMA1 to iGMA14 may be eight selection signals.

For example, a first selection circuit 316_1 may output any one gamma reference voltage, selected from 256 voltages generated by distributing a voltage difference between a first voltage node N1 and a second voltage node N2, to a first buffer 318_1 in response to first selection signals iGMA1.

A seventh selection circuit 316_7 may output any one gamma reference voltage, selected from 256 voltages generated by distributing a voltage between a third voltage node N3 and a fourth voltage node N4, to a seventh buffer 318_7 in response to seventh selection signals iGMA7.

An eighth selection circuit 316_8 may output any one gamma reference voltage, selected from 256 voltages generated by distributing a voltage difference between the fourth voltage node N4 and a fifth voltage node N5, to an eighth buffer 318_8 in response to eighth selection signals iGMA8.

A fourteenth selection circuit 316_14 may output any one gamma reference voltage, selected from 256 voltages generated by distributing a voltage difference between a sixth voltage node N6 and a seventh voltage node N7, to a fourteenth buffer 318_14 in response to fourteenth selection signals iGMA14.

That is, the selection circuits 316_2 to 316_6 and 316_9 to 316_13 may output gamma reference voltages to the respective buffers 318_2 to 318_6 and 318_9 to 318_13 in response to the corresponding selection signals iGMA2 to iGMA6 and iGMA9 to iGMA13.

Among the plurality of buffers 318_1 to 318_14, operating voltages of a first group of buffers 318_1 to 318_7 are the first operating voltage VDDH and the second operating voltage HVDD, and operating voltages of a second group of buffers 318_8 to 318_14 are the second operating voltage HVDD and the ground voltage VSSH.

The first group of buffers 318_1 to 318_7 respectively receive gamma reference voltages from a first group (e.g., output signals of the selection circuits 316_1 to 316_7), and the second group of buffers 318_8 to 318_14 respectively receive gamma reference voltages from a second group (e.g., output signals of the selection circuits 316_8 to 316_14).

The first buffer 318_1 receives and buffers the output signal of the first selection circuit 316_1 to generate a first intermediate grayscale voltage VGMAO1. The first intermediate grayscale voltage VGMAO1 is supplied to the first level shifter circuit 230_1 through a first grayscale voltage transmission line 301 connected to a first pad PAD1.

A second buffer 318_2 receives and buffers the output signal of a second selection circuit 316_2 to generate a second intermediate grayscale voltage VGMAO2.

A sixth buffer 318_6 receives and buffers the output signal of a sixth selection circuit 316_6 to generate a sixth intermediate grayscale voltage VGMAO6, and the seventh buffer 318_7 receives and buffers the output signal of the seventh selection circuit 316_7 to generate a seventh intermediate grayscale voltage VGMAO7.

The eighth buffer 318_8 receives and buffers the output signal of the eighth selection circuit 316_8 to generate an eighth intermediate grayscale voltage VGMAO8. The eighth intermediate grayscale voltage VGMAO8 is supplied to the second level shifter circuit 230_2 through a second grayscale voltage transmission line 303 connected to a second pad PAD2.

A ninth buffer 318_9 receives and buffers the output signal of a ninth selection circuit 316_9 to generate a ninth intermediate grayscale voltage VGMAO9, a thirteenth buffer 318_13 receives and buffers the output signal of a thirteenth selection circuit 316_13 to generate a thirteenth intermediate grayscale voltage VGMA13, and the fourteenth buffer 318_14 receives and buffers the output signal of the fourteenth selection circuit 316_14 to generate a fourteenth intermediate grayscale voltage VGMA14.

The second resistor string 320 includes a second group of resistors connected in series between the output terminal of the first buffer 318_1 and the output terminal of the seventh buffer 318_7, generates a first group of grayscale voltages VGMA_VH0 to VGMA_VH255 using the intermediate grayscale voltages VGMAO1 to VGMAO7 outputted from the first group of buffers 318_1 to 318_7, and outputs the first group of grayscale voltages VGMA_VH0 to VGMA_VH255 to the first DAC 240_1.

Among the first group of grayscale voltages VGMA_VH0 to VGMA_VH255, the highest grayscale voltage is VGMA_VH255 (=VGMAO1), and the lowest grayscale voltage is VGMA_VH0 (=VGMAO7). VGMA_VH255 (=VGMAO1) is the grayscale voltage closest to the first operating voltage VDDH among the first group of grayscale voltages VGMA_VH0 to VGMA_VH255, while VGMA_VH0 (=VGMAO7) is the grayscale voltage closest to the second operating voltage HVDD.

The third resistor string 320 includes a third group of resistors connected in series between the output terminal of the eighth buffer 318_8 and the output terminal of the fourteenth buffer 318_14, generates a second group of grayscale voltages VGMA_VL0 to VGMA_VL255 using the intermediate grayscale voltages VGMAO8 to VGMA14 outputted from the second group of buffers 318_8 to 318_14, and outputs the second group of grayscale voltages VGMA_VL0 to VGMA_VL255 to the second DAC 240_2.

Among the second group of grayscale voltages VGMA_VL0 to VGMA_VL255, the highest grayscale voltage is VGMA_VL0 (=VGMAO8) and the lowest grayscale voltage is VGMA_VL255 (=VGMA14). VGMA_VL0 (=VGMAO8) is the grayscale voltage closest to the second operating voltage HVDD among the second group of grayscale voltages VGMA_VL0 to VGMA_VL255, while the VGMA_VL255 (=VGMAO14) is the grayscale voltage closest to the ground voltage VSSH.

In FIG. 4, for simplicity of description, the grayscale voltage generation circuit 300 including fourteen selection circuits 316_1 to 316_8 and fourteen buffers 318_1 to 318_14 has been illustrated and described, but this is merely an example.

Since the buffers 318_1 to 318_14 share a power line (not shown) for supplying the second operating voltage HVDD, a current caused by a potential difference between the first operating voltage VDDH and the second operating voltage HVDD may be additionally supplied to the second level shifter circuit 230_2, thereby further reducing the current consumed by the second level shifter circuit 230_2. As a result, the current consumption of the source driver IC 100 is also reduced.

In addition, the second group of buffers 318_8 to 318_14 share charges generated by the first group of buffers 318_1 to 318_7. As the charges are shared, a dynamic current consumed by the switching of each of CMOS transmission gates CTR included in the second DAC 240_2 may be reduced.

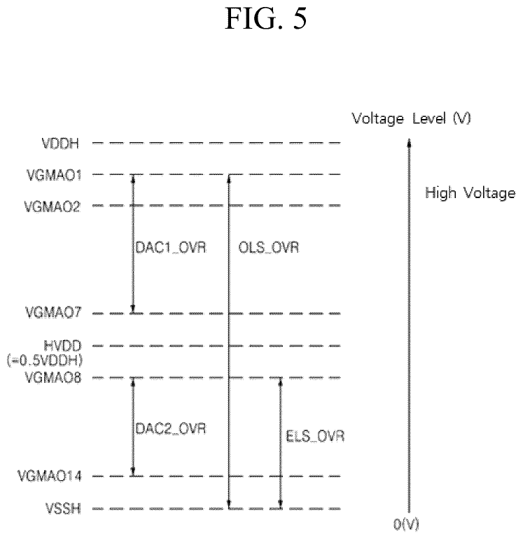

FIG. 5 illustrates a range of voltage levels used in the source driver IC of FIG. 2.

Referring to FIGS. 2, 4, and 5, an output voltage swing range OLS_OVR of first level shifters 232_1 to 232_8 is between the highest grayscale voltage VGMAO1=VGMA_VH255 among the first group of grayscale voltages VGMA_VH0 to VGMA_VH255 and the ground voltage VSSH.

In this way, since VGMAO1 (=VGMA_VH255), which is lower than the first operating voltage VDDH, is applied to the high-potential voltage input side of the first level shifters 232_1 to 232_8, a current corresponding to a voltage difference between the first operating voltage VDDH and VGMAO1 may be reduced compared to a typical level shifter in which the first operating voltage VDDH is applied to the high-potential voltage input side.

An output voltage swing range ELS_OVR of second level shifters 234_1 to 234_8 is between the highest grayscale voltage VGMA_VL0 (=VGMAO8) among the second group of grayscale voltages VGMA_VL0 to VGMA_VL255 and the ground voltage VSSH.

In this way, since VGMAO8 (=VGMA_VL0), which is lower than the first operating voltage VDDH, is applied to the high-potential voltage input side of the second level shifters 234_1 to 234_8, a current corresponding to a voltage difference between the first operating voltage VDDH and VGMAO8 may be reduced compared to a typical level shifter in which the first operating voltage VDDH is applied to the high-potential voltage input side.

Additionally, as the first group of grayscale voltages VGMA_VH0 to VGMA_VH255 are supplied to the first DAC 240_1, an output voltage swing range DAC1_OVR of the first DAC 240_1 is between the first intermediate grayscale voltage VGMAO1 (=VGMA_VH255) and the seventh intermediate grayscale voltage VGMAO7 (=VGMA_VH0).

As the second group of grayscale voltages VGMA_VL0 to VGMA_VL255 are supplied to the second DAC 240_2, an output voltage swing range DAC2_OVR of the second DAC 240_2 is between the eighth intermediate grayscale voltage VGMAO8 (=VGMA_VL0) and the fourteenth intermediate grayscale voltage VGMA14 (=VGMA_VL255).

FIG. 6 is a circuit diagram of a first level shifter of the source driver IC shown in FIG. 2.

The first level shifter circuit 230_1 includes the plurality of first level shifters 232_1 to 232_8. Since the structures and operations of the first level shifters 232_1 to 232_8 are identical, the structure and operation of the first level shifter 232_1 are representatively described with reference to FIG. 6.

Transistors MP1_1, MP1_3, and MN1_1 are connected in series between the first grayscale voltage transmission line 301 for transmitting the first intermediate grayscale voltage VGMAO1 (=VGMA_VH255) and the ground GND that supplies the ground voltage VSSH, and transistors MP1_2, MP1_4, and MN1_2 are connected in series between the first grayscale voltage transmission line 301 and the ground GND.

Since the bias voltage LSP having a low level is supplied to each of the gate of a first PMOS transistor MP1_1 and the gate of a second PMOS transistor MP1_2, the first and second PMOS transistors MP1_1 and MP1_2 are turned on. The first and second PMOS transistors MP1_1 and MP1_2 may always maintain a turned-on state by the bias voltage LSP supplied to their gates. As the bias voltage LSP is supplied to the gate of the first PMOS transistor MP1_1 and the gate of the second PMOS transistor MP1_2 and the first and second PMOS transistors MP1_1 and MP1_2 are turned on, a current flowing through a third PMOS transistor MP1_3 and a fourth PMOS transistor MP1_4 is limited.

The gate of the third PMOS transistor MP1_3 is connected to a second node ND2, the first terminal of the third PMOS transistor MP1_3 is connected to a first node ND1, and the second terminal of the third PMOS transistor MP1_3 is connected to the first PMOS transistor MP1_1. The gate of the fourth PMOS transistor MP1_4 is connected to the first node ND1, the first terminal of the fourth PMOS transistor MP1_4 is connected to the second node ND2, and the second terminal of the fourth PMOS transistor MP1_4 is connected to the second PMOS transistor MP1_2.

The output signal (also referred to as “first input data” or “first bit”) 2LH1_1 of the first latch 222_1 included in the second latch circuit 220_1 is inputted to the gate of a first NMOS transistor MN1_1, a first inverter INV1 inverts the output signal 2LH1_1 of the first latch 222_1, and an inverted output signal 2LHB1_1 is inputted to the gate of a second NMOS transistor MN1_2.

For example, when the level of the signal 2LH1_1 inputted to the gate of the first NMOS transistor MN1_1 is high and the level of the signal 2LHB1_1 inputted to the gate of the second NMOS transistor MN1_2 is low, the first NMOS transistor MN1_1 is turned on and the second NMOS transistor MN1_2 is turned off.

When the first NMOS transistor MN1_1 is turned on, a voltage DB1_1 at the first node ND1 is pulled down to the ground voltage VSSH and the fourth PMOS transistor MP1_4 is turned on, causing a voltage D1_1 at the second node ND2 to be pulled up to the level of the first operating voltage (VGMAO1=VGMA_VH255). Accordingly, the third PMOS transistor MP1_3 is turned off, and thus the voltage DB1_1 at the first node ND1 maintains the ground voltage VSSH.

Conversely, when the level of the signal 2LH1_1 inputted to the gate of the first NMOS transistor MN1_1 is low and the level of the signal 2LHB1_1 inputted to the gate of the second NMOS transistor MN1_2 is high, the first NMOS transistor MN_1 is turned off and the second NMOS transistor MN1_2 is turned on.

When the second NMOS transistor MN1_2 is turned on, the voltage D1_1 at the second node ND2 is pulled down to the ground voltage VSSH and the third PMOS transistor MP1_3 is turned on, causing the voltage DB1_1 at the first node ND1 to be pulled up to the level of the first operating voltage (VGMAO1=VGMA_VH255). Accordingly, the fourth PMOS transistor MP1_4 is turned off, and thus the voltage D1_1 at the second node ND2 maintains the ground voltage VSSH.

The voltage level DB1_1 at the first node ND1 is complementary to the voltage level D1_1 at the second node ND2.

As shown in FIG. 5, the output voltage swing range OLS_OVR of the voltage levels DB1_1 and D1_1 at the first node ND1 and the second node ND2 is between the highest grayscale voltage VGMA_VH255 (=VGMAO1) among the first group of grayscale voltages VGMA_VH0 to VGMA_VH255 and the ground voltage VSSH.

As described with reference to FIG. 2, the first level shifters 232_1 to 232_8 output complementary signal pairs <D1_1, DB1_1> to <D1_8, DB1_8> to the first DAC 240_1.

For example, the voltage swing range of the output signals D1_1 to D1_8 of the first level shifters 232_1 to 232_8 is greater than the voltage swing range of the input/output signals of each of the latches 212_1 to 212_8 and 222_1 to 222_8.

FIG. 7 is a circuit diagram of a second level shifter of the source driver IC shown in FIG. 2.

The second level shifter circuit 230_2 includes the plurality of second level shifters 234_1 to 234_8. Since the structures and operations of the second level shifters 234_1 to 234_8 are identical, the structure and operation of the second level shifter 234_1 are representatively described with reference to FIG. 7.

For example, when describing two level shifters 232_j and 234_j (where 1≤Âj≤8), the first level shifter may refer to the level shifter 232_j, and the second level shifter may refer to the level shifter 234_j.

Each of the second level shifters 234_1 to 234_8 and each of the first level shifters 232_1 to 232_8 operate independently of each other. Additionally, the first level shifters 232_1 to 232_8 operate independently of each other, and the second level shifters 234_1 to 234_8 operate independently of each other.

For example, the output signals of any one of the first level shifters 232_1 to 232_8 and 234_1 to 234_8 have no effect on the input signals of each of the remaining level shifters.

Transistors MP2_1, MP2_3, and MN2_1 are connected in series between the second grayscale voltage transmission line 303 for transmitting the eighth intermediate grayscale voltage VGMAO8 (=VGMA_VL0) and the ground GND that supplies the ground voltage VSSH, and transistors MP2_2, MP2_4, and MN2_2 are connected in series between the second grayscale voltage transmission line 303 and the ground GND.

Since the bias voltage LSP having a low level is supplied to each of the gate of a first PMOS transistor MP2_1 and the gate of a second PMOS transistor MP2_2, the first and second PMOS transistors MP2_1 and MP2_2 are turned on. The first and second PMOS transistors MP2_1 and MP2_2 may always maintain a turned-on state by the bias voltage LSP supplied to their gates. As the bias voltage LSP is supplied to the gate of the first PMOS transistor MP2_1 and the gate of the second PMOS transistor MP2_2 and the first and second PMOS transistors MP2_1 and MP2_2 are turned on, a current flowing through a third PMOS transistor MP2_3 and a fourth PMOS transistor MP2_4 is limited.

The gate of the third PMOS transistor MP2_3 is connected to a fourth node ND4, the first terminal of the third PMOS transistor MP2_3 is connected to a third node ND3, and the second terminal of the third PMOS transistor MP2_3 is connected to the first PMOS transistor MP2_1. The gate of the fourth PMOS transistor MP2_4 is connected to the third node ND3, the first terminal of the fourth PMOS transistor MP2_4 is connected to the fourth node ND4, and the second terminal of the fourth PMOS transistor MP2_4 is connected to the second PMOS transistor MP2_2.

The output signal (also referred to as “second input data” or “first bit”) 2LH2_1 of the first latch 224_1 included in the second latch circuit 220_2 is inputted to the gate of a first NMOS transistor MN2_1, a second inverter INV2 inverts the output signal 2LH2_1 of the first latch 224_1, and an inverted output signal 2LHB2_1 is inputted to the gate of a second NMOS transistor MN2_2.

For example, when the level of the signal 2LH2_1 inputted to the gate of the first NMOS transistor MN2_1 is high and the level of the signal 2LHB2_1 inputted to the gate of the second NMOS transistor MN2_2 is low, the first NMOS transistor MN2_1 is turned on and the second NMOS transistor MN2_2 is turned off.

When the first NMOS transistor MN2_1 is turned on, a voltage DB2_1 at the third node ND3 is pulled down to the ground voltage VSSH, and the fourth PMOS transistor MP2_4 is turned on, causing a voltage D2_1 at the fourth node ND4 to be pulled up to the level of the second operating voltage (VGMAO8). Accordingly, the third PMOS transistor MP2_3 is turned off, and thus the voltage DB2_1 at the third node ND3 maintains the ground voltage VSSH.

Conversely, when the level of the signal 2LH2_1 inputted to the gate of the first NMOS transistor MN2_1 is low and the level of the signal 2LHB2_1 inputted to the gate of the second NMOS transistor MN2_2 is high, the first NMOS transistor MN2_1 is turned off and the second NMOS transistor MN2_2 is turned on.

When the second NMOS transistor MN2_2 is turned on, the voltage D2_1 at the fourth node ND4 is pulled down to the ground voltage VSSH, and the third PMOS transistor MP2_3 is turned on, causing the voltage DB2_1 at the third node ND3 to be pulled up to the level of the second operating voltage (VGMAO8). Accordingly, the fourth PMOS transistor MP2_4 is turned off, and thus the voltage D2_1 at the fourth node ND4 maintains the ground voltage VSSH.

The voltage level DB2_1 at the third node ND3 is complementary to the voltage level D2_1 at the fourth node ND4.

As shown in FIG. 5, the output voltage swing range ELS_OVR of the voltage levels DB2_1 and D2_1 at the third node ND3 and the fourth node ND4 is between the highest grayscale voltage VGMA_VL0 (=VGMAO8) among the second group of grayscale voltages VGMA_VL0 to VGMA_VL255 and the ground voltage VSSH.

As described with reference to FIG. 2, the second level shifters 234_1 to 234_8 output complementary signal pairs <D2_1, DB2_1> to <D2_8, DB2_8> to the second DAC 240_2.

For example, the voltage swing range ELS_OVR of the output signals D2_1 to D2_8 of the second level shifters 234_1 to 234_8 is greater than the voltage swing range of the input/output signals of each of the latches 212_1 to 212_8 and 222_1 to 222_8, and is smaller than the voltage swing range OLS_OVR of the output signals D1_1 to D1_8 of the first level shifters 232_1 to 232_8.

As shown in FIG. 2, the first level shifters 232_1 to 232_8 operate independently of the second level shifters 234_1 to 234_8.

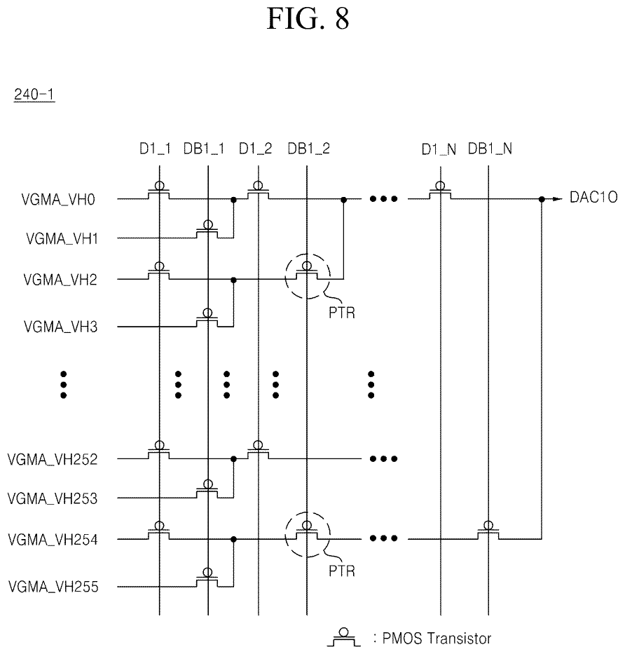

FIG. 8 is a circuit diagram of a first digital-to-analog converter of the source driver IC shown in FIG. 2.

Referring to FIGS. 2 and 8, the first DAC 240_1 outputs any one of the first group of grayscale voltages VGMA_VH0 to VGMA_VH255 as a first output signal DAC1O in response to the complementary signal pairs <D1_1, DB1_1> to <D1_8, DB1_8> outputted from the first level shifters 232_1 to 232_8.

Referring to FIG. 8, the first DAC 240_1 includes switches (e.g., PMOS transistors) PTR.

For example, when the 8-bit parallel data D1_1 to D1_8 outputted from the first level shifter circuit 230_1 is 00000000, the first DAC 240_1 outputs a 1^{st} grayscale voltage VGMA_VH0 as the first output signal DAC1O, and when the 8-bit parallel data D1_1 to D1_8 outputted from the first level shifter circuit 230_1 is 00000001, the first DAC 240_1 outputs a 2^{nd} grayscale voltage VGMA_VH1 as the first output signal DAC1O. When the 8-bit parallel data D1_1 to D1_8 outputted from the first level shifter circuit 230_1 is 11111110, the first DAC 240_1 outputs a 255^{th} grayscale voltage VGMA_VH254 as the first output signal DAC1O, and when the 8-bit parallel data D1_1 to D1_8 outputted from the first level shifter circuit 230_1 is 11111111, the first DAC 240_1 outputs a 256^{th} grayscale voltage VGMA_VH255 as the first output signal DAC1O.

The first output circuit 250_1 buffers the first output signal DAC1O of the first DAC 240_1 and outputs the buffered first output signal OUT1 to at least one of the first data lines DL1.

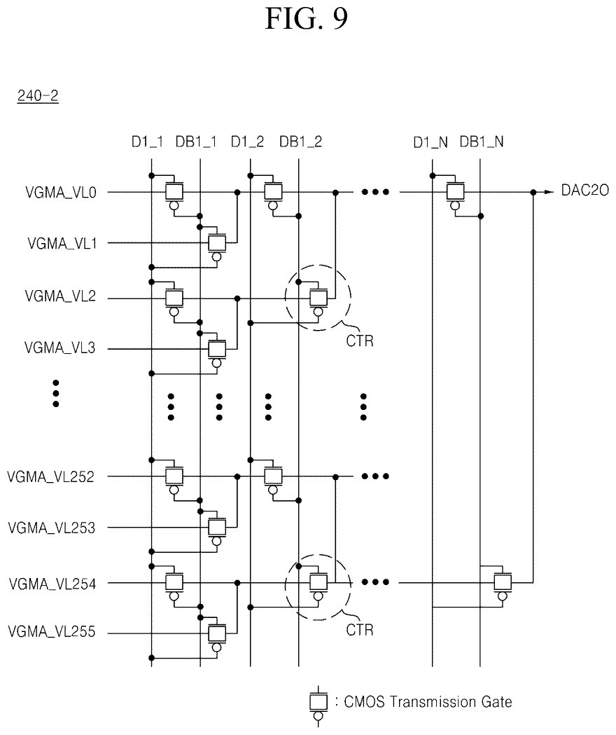

FIG. 9 is a circuit diagram of a second digital-to-analog converter of the source driver IC shown in FIG. 2.

Referring to FIGS. 2 and 9, the second DAC 240_2 outputs any one of the second group of grayscale voltages VGMA_VL0 to VGMA_VL255 as a second output signal DAC2O in response to the complementary signal pairs <D2_1, DB2_1> to <D2_8, DB2_8> outputted from the second level shifters 232_1 to 232_8.

Referring to FIG. 9, the second DAC 240_2 includes the switches (e.g., CMOS transmission gates) CTR.

For example, when the 8-bit parallel data D2_1 to D2_8 outputted from the second level shifter circuit 230_2 is 00000000, the second DAC 240_2 outputs a 1^{st} grayscale voltage VGMA_VL0 as the second output signal DAC2O, and when the 8-bit parallel data D2_1 to D2_8 outputted from the second level shifter circuit 230_2 is 00000001, the second DAC 240_2 outputs a 2^{nd} grayscale voltage VGMA_VL1 as the second output signal DAC2O. When the 8-bit parallel data D2_1 to D2_8 outputted from the second level shifter circuit 230_2 is 11111110, the second DAC 240_2 outputs a 255^{th} grayscale voltage VGMA_VL254 as the second output signal DAC2O, and when the 8-bit parallel data D2_1 to D2_8 outputted from the second level shifter circuit 230_2 is 11111111, the second DAC 240_2 outputs a 256th grayscale voltage VGMA_VL255 as the second output signal DAC2O.

In FIG. 9, the switches of the second DAC 240_2 are illustrated as the CMOS transmission dates CTR, but this is merely an example, and the switches of the second DAC 240_2 may be composed of NMOS transistors NTR.

The second output circuit 250_2 buffers the second output signal DAC2O of the second DAC 240_2 and outputs the buffered second output signal OUT2 to another one of the first data lines DL1.

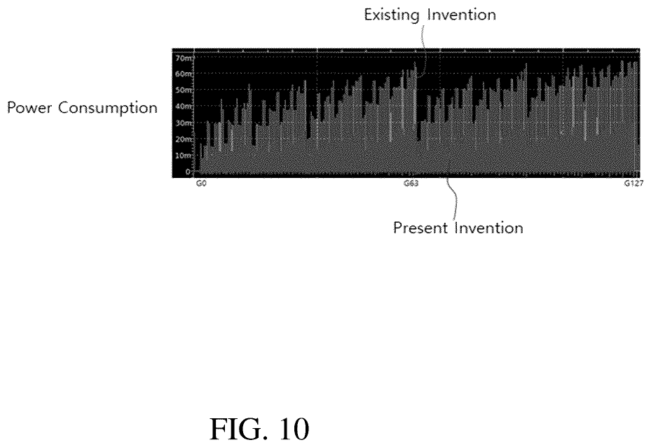

FIG. 10 is a graph illustrating a comparison between power consumption of a source driver IC according to the present invention and power consumption of a typical source driver IC. As shown in FIG. 10, it can be seen that the power consumption of the source driver IC according to the present invention is reduced to half or less of the power consumed by the typical source driver IC.

Those skilled in the art to which the present invention belongs will understand that the present invention described above may be implemented in other specific forms without changing its technical idea or essential features.

Therefore, it should be understood that the embodiments described above are illustrative in all aspects and do not limit the present invention. The scope of the present invention is represented by the following claims rather than the above detailed description, and it should be construed that all changes or modifications derived from the meaning and scope of the claims and their equivalent concepts are included within the scope of the present invention.

### MODE FOR CARRYING OUT THE INVENTION

Various embodiments for carrying out the present invention have been sufficiently described in the preceding subheadings.

### INDUSTRIAL APPLICABILITY

Since the present invention is applicable to various types of display devices, its industrial applicability is recognized.

1. A display driving device comprising:
a grayscale voltage generation circuit configured to generate a plurality of grayscale voltages using a first operating voltage and a ground voltage;
a level shifter configured to level-shift a voltage of input data to a target grayscale voltage, which is lower than the first operating voltage among the plurality of grayscale voltages, using the target grayscale voltage; and
a grayscale voltage transmission line configured to transmit the target grayscale voltage from the grayscale voltage generation circuit to the level shifter.

2. The display driving device of claim 1, wherein the grayscale voltage transmission line includes:
a first grayscale voltage transmission line configured to transmit a first grayscale voltage as the target grayscale voltage; and
a second grayscale voltage transmission line configured to transmit, as the target grayscale voltage, a second grayscale voltage lower than the first grayscale voltage, and
wherein the level shifter includes:
a first level shifter connected between the first grayscale voltage transmission line and a ground that supplies the ground voltage, and configured to level-shift a voltage of first input data among the input data to the first grayscale voltage; and
a second level shifter connected between the second grayscale voltage transmission line and the ground, and configured to level-shift a voltage of second input data among the input data to the second grayscale voltage.

3. The display driving device of claim 2, wherein:
the first input data is a first bit among N-bit odd-numbered data,
the second input data is a first bit among N-bit even-numbered data, and
the N-bit even-numbered data is data immediately following the N-bit odd-numbered data, and N is a natural number of 2 or more.

4. The display driving device of claim 2, wherein the first level shifter and the second level shifter operate independently of each other.

5. The display driving device of claim 2, wherein:
the first grayscale voltage is higher than a second operating voltage,
the second grayscale voltage is lower than the second operating voltage, and
the second operating voltage is half of the first operating voltage.

6. The display driving device of claim 2, wherein:
the grayscale voltages include a first group of grayscale voltages and a second group of grayscale voltages,
the grayscale voltage generation circuit generates the first group of grayscale voltages using the first operating voltage and a second operating voltage, and generates the second group of grayscale voltages using the second operating voltage and the ground voltage,
the first grayscale voltage is lower than the first operating voltage and is the highest grayscale voltage among the first group of grayscale voltages,
the second grayscale voltage is lower than the second operating voltage and is the highest grayscale voltage among the second group of grayscale voltages, and
the second operating voltage is half of the first operating voltage.

7. A display device comprising:
a source driver IC configured to drive data lines included in a display panel; and
a timing controller configured to transmit input data to be displayed through the display panel to the source driver IC and control an operation of the source driver IC,
wherein the source driver IC includes:
a grayscale voltage generation circuit configured to generate a first group of grayscale voltages using a first operating voltage and a second operating voltage, and generate a second group of grayscale voltages using the second operating voltage and a ground voltage;
a first grayscale voltage transmission line configured to transmit a first grayscale voltage among the first group of grayscale voltages;
a second grayscale voltage transmission line configured to transmit a second grayscale voltage among the second group of grayscale voltages;
first level shifters, each connected between the first grayscale voltage transmission line and a ground that supplies the ground voltage, and configured to level-shift a voltage of each bit included in first parallel data among the input data to the first grayscale voltage; and
second level shifters, each connected between the second grayscale voltage transmission line and the ground, and configured to level-shift a voltage of each bit included in second parallel data among the input data to the second grayscale voltage.

8. The display device of claim 7, wherein:
the first level shifters and the second level shifters operate independently of each other,
the first parallel data is odd-numbered data among the input data and the second parallel data is even-numbered data among the input data, and
the second parallel data is data immediately following the first parallel data.

9. The display device of claim 7, wherein:
the first grayscale voltage is lower than the first operating voltage and higher than the second operating voltage,
the second grayscale voltage is lower than the second operating voltage, and
the second operating voltage is half of the first operating voltage.

10. The display device of claim 7, wherein:
the first grayscale voltage is lower than the first operating voltage and is the highest grayscale voltage among the first group of grayscale voltages,
the second grayscale voltage is lower than the second operating voltage and is the highest grayscale voltage among the second group of grayscale voltages, and
the second operating voltage is half of the first operating voltage.
